(19) United States
(12) Patent Application Publication
(10) Pub. No.: US 2026/0253596 A1
(43) Pub. Date: Aug. 27, 2026

(54) Hearing Enhancement Controls and Modes for Artificial Reality Systems

(71) Applicant: Meta Platforms Technologies, LLC, Menlo Park, CA (US)

(72) Inventors: Vicki CHANG, Santa Clara, CA (US); Holly Marie ORMSETH, Berkeley, CA (US); Camila Cortes DE ALMEIDA E DE VINCENZO, Seattle, WA (US); Jan LINDEN, San Francisco, CA (US); Francesco NESTA, Aliso Viejo, CA (US); Alexander REICH, Seattle, WA (US); Andreas Thelander BERTELSEN, San Francisco, CA (US)

(21) Appl. No.: 19/059,752

(22) Filed: Feb. 21, 2025

(51) Int. Cl. G10L 21/0216; G06F 3/01

(52) U.S. Cl. CPC G10L 21/0216; G06F 3/017; G10L 2021/02166

(57) ABSTRACT

Aspects of the present disclosure relate to hearing enhancement controls and modes for artificial reality (XR) systems. A hearing enhancement system can provide a wearer of an XR system, such as augmented reality (AR) glasses, heightened hearing for a conversation by accentuating a particular voice for the wearer. In some implementations, the system can 1) select a particular voice to accentuate, 2) apply filter(s) that eliminate sounds other than the selected voice, and 3) set the amount of amplification for the filtered voice based on a determined amount of residual noise in the filtered voice signal, such that the residual amount of noise is obscured from the wearer. In some implementations, the system can set the amount of amplification instead based on a determined amount of ambient noise in an audio signal, then filter the audio signal to a level that keeps the resulting residual noise below the ambient noise.

### TECHNICAL FIELD

The present disclosure is directed to selectively enhancing audio in a real-world environment using an artificial reality (XR) system.

### BACKGROUND

Hearing devices, such as headsets, hearing aids, headphones, mobile devices, and ear buds, provide sound for the wearer. Hearing aids amplify ambient sound to compensate for a user's hearing loss via circuitry that directs the amplified sound into the ear canal. For example, a hearing aid typically has a microphone, an amplifier, and a speaker. The microphone can receive an acoustic signal, convert it to an electrical signal, and transmit it to an amplifier. The amplifier can increase the power of the signal to a degree determined by the user's hearing loss, and transmit it to the ear via the speaker. Other hearing devices can play sound through a speaker having manually adjustable volume control. In some environments, it may be difficult for a user to distinguish target sound from other sounds, such as environmental or background noise.

### BRIEF DESCRIPTION OF THE DRAWINGS

FIG. 1 is a block diagram illustrating an overview of devices on which some implementations of the present technology can operate.

FIG. 2A is a wire diagram illustrating a virtual reality headset which can be used in some implementations of the present technology.

FIG. 2B is a wire diagram illustrating a mixed reality headset which can be used in some implementations of the present technology.

FIG. 2C is a wire diagram illustrating controllers which, in some implementations, a user can hold in one or both hands to interact with an artificial reality environment.

FIG. 3 is a block diagram illustrating an overview of an environment in which some implementations of the present technology can operate.

FIG. 4 is a block diagram illustrating components which, in some implementations, can be used in a system employing the disclosed technology.

FIG. 5A is a flow diagram illustrating a first process used in some implementations of the present technology for providing hearing enhancement by an artificial reality (XR) system.

FIG. 5B is a flow diagram illustrating a second process used in some implementations of the present technology for providing hearing enhancement by an XR system.

FIG. 6A is a graph illustrating an exemplary filtered audio signal, including a target audio signal and residual noise.

FIG. 6B is a graph illustrating an exemplary filtered audio signal that has been adjusted to reduce the overall amount of residual noise.

FIG. 6C is a graph illustrating an exemplary filtered audio signal that has been dynamically adjusted over multiple time periods to reduce the amount of residual noise in a particular time period.

FIG. 7A is an exemplary user interface for selecting and controlling a focus mode of a hearing enhancement system according to some implementations of the present technology.

FIG. 7B is an exemplary user interface for selecting and controlling a surround mode of a hearing enhancement system according to some implementations of the present technology.

FIG. 7C is an exemplary user interface for selecting and controlling an adaptive mode of a hearing enhancement system according to some implementations of the present technology.

The techniques introduced here may be better understood by referring to the following Detailed Description in conjunction with the accompanying drawings, in which like reference numerals indicate identical or functionally similar elements.

### DETAILED DESCRIPTION

Aspects of the present disclosure relate to hearing enhancement controls and modes for artificial reality (XR) systems. A hearing enhancement system can provide a wearer of an XR system, such as augmented reality (AR) glasses, heightened hearing, e.g., for a conversation by accentuating a particular voice for the wearer. For example, the hearing enhancement system can estimate an acoustic ambient noise level from a raw audio signal captured by a microphone on the AR glasses. Based on the acoustic ambient noise level, the hearing enhancement system can select and apply a certain amplification gain to the audio signal, e.g., to increase intelligibility or reduce listening effort, without applying large amplification if it is not needed. Based on the target amplification level applied (which can depend on the estimated ambient noise), the hearing enhancement system can determine how much noise suppression (e.g., filtering to remove ambient noise and/or lowering the volume of ambient noise) should be applied. The amount of noise suppression to apply can be selected such that the final amount of residual noise that will be output, in the noise-suppressed audio signal, stays below the estimated amount of ambient noise, and thus is masked by the ambient noise in the environment. However, the selected amount of noise suppression can be capped at a particular threshold, as applying too much noise suppression can potentially result in a greater number of artifacts to the enhanced target speech (e.g., a particular voice or set of voices). In some implementations, the amount of noise suppression to apply to an amplified audio signal can be selected by applying a predefined transform function defining an amount of reduction of ambient noise in the signal that will not result in an unacceptable amount of artifacts to the amplified speech. This predefined transform function can be created though a previous analysis of how various transfer function parameters affect artifacts in filtered audio and how noticeable residual noise is in filtered audio in relation to the ambient noise.

In some implementations, the hearing enhancement system can have three modes: A) a “focus” mode, B) a “surround” mode, and C) an “adaptive” mode. In A) the focus mode, the hearing enhancement can select the target audio signal to amplify based on the position of the audio source relative to the user, e.g., a person speaking in front of the user. In such implementations, the hearing enhancement system can select and amplify the target audio signal based on the directionality of capture of the target audio signal relative to an array of microphones on the XR system. In B) the surround mode, the hearing enhancement system can select an amplify audio captured from a wider range of audio sources relative to the user. For example, instead of focusing on a narrow target area of capture and amplification as in the focus mode (e.g., within a 45 degree outwardly extending angle relative to the head position of the user), the hearing enhancement system can broaden the target area (e.g., to within a 120 degree outwardly extending angle relative to the head position of the user). In some implementations, the focus mode can be selected for an environment with a higher ambient noise level (e.g., above a threshold), while the surround mode can be selected for an environment with a lower ambient noise level (e.g., below the threshold). In C) the adaptive mode, the hearing enhancement system can dynamically adjust the area from which audio is received to amplify. For example, as the user traverses the environment and moves from an environment having lower ambient noise to an environment having higher ambient noise, the hearing enhancement system can adjust the target area to become smaller (e.g., switch from the surround mode to the focus mode). In the adaptive mode, the hearing enhancement system can further dynamically adjust the directionality from which a target audio signal is selected. For example, if a person speaking in front of the user moves to the left of the user, the hearing enhancement system can adjust the target area to correspondingly move to the left.

In other implementations, the hearing enhancement system can 1) select a particular audio signal to accentuate based on a direction of the audio signal relative to the glasses (e.g., who is in front of the wearer) determined using an array of microphones, 2) apply a combined filter that eliminates sounds other than the selected audio signal, and 3) set the amount of amplification for the filtered audio signal based on a determined amount of residual noise in the filtered audio signal, such that the residual amount of noise is obscured from the wearer by ambient noise (i.e., noise the user can hear that is not being output by the XR system) and/or by the filtered audio signal. In some implementations, the hearing enhancement system can be activated based on a wearer of the XR system performing a “tap and hold” gesture with three fingers on the side of the XR system (e.g., augmented reality (AR) glasses).

Embodiments of the disclosed technology may include or be implemented in conjunction with an artificial reality system. Artificial reality or extra reality (XR) is a form of reality that has been adjusted in some manner before presentation to a user, which may include, e.g., virtual reality (VR), augmented reality (AR), mixed reality (MR), hybrid reality, or some combination and/or derivatives thereof. Artificial reality content may include completely generated content or generated content combined with captured content (e.g., real-world photographs). The artificial reality content may include video, audio, haptic feedback, or some combination thereof, any of which may be presented in a single channel or in multiple channels (such as stereo video that produces a three-dimensional effect to the viewer). Additionally, in some embodiments, artificial reality may be associated with applications, products, accessories, services, or some combination thereof, that are, e.g., used to create content in an artificial reality and/or used in (e.g., perform activities in) an artificial reality. The artificial reality system that provides the artificial reality content may be implemented on various platforms, including a head-mounted display (HMD) connected to a host computer system, a standalone HMD, a mobile device or computing system, a “cave” environment or other projection system, or any other hardware platform capable of providing artificial reality content to one or more viewers. In some cases, the artificial reality system can provide an augmented experience for a user without a display, such as by capturing and/or providing audio and/or other non-visual multimedia content. For example, the artificial reality system can include headphones (or other over-the-ear devices), ear buds (or other in-ear devices), glasses having one or more multimedia capabilities with inert lenses, etc. “Virtual reality” or “VR,” as used herein, refers to an immersive experience where a user's visual input is controlled by a computing system. “Augmented reality” or “AR” refers to systems where a user views images of the real world after they have passed through a computing system. For example, a tablet with a camera on the back can capture images of the real world and then display the images on the screen on the opposite side of the tablet from the camera. The tablet can process and adjust or “augment” the images as they pass through the system, such as by adding virtual objects. “Mixed reality” or “MR” refers to systems where light entering a user's eye is partially generated by a computing system and partially composes light reflected off objects in the real world. For example, a MR headset could be shaped as a pair of glasses with a pass-through display, which allows light from the real world to pass through a waveguide that simultaneously emits light from a projector in the MR headset, allowing the MR headset to present virtual objects intermixed with the real objects the user can see. “Artificial reality,” “extra reality,” or “XR,” as used herein, refers to any of VR, AR, MR, or any combination or hybrid thereof.

The implementations described herein provide specific technological improvements in the field of hearing enhancement. In some implementations, the hearing enhancement system can estimate ambient noise in an audio signal, separate from a target signal (e.g., a voice), and apply an amplification level based on the estimated amount of ambient noise. The hearing enhancement system can further select a level of noise suppression to apply to the amplified audio signal, such that any residual noise left in the signal is at a level below the amount of ambient noise in the environment, thereby masking the residual noise. In some implementations, the level of noise suppression applied can be capped at a predetermined threshold based on an acceptable amount of artifacts that could result in the amplified target signal, as higher levels of noise suppression can result in a greater amount of artifacts. Thus, the implementations described herein improve on conventional hearing enhancement techniques by removing as much unwanted noise as possible from an audio signal (without resulting in an unacceptable level of artifacts to the target signal, such as a voice), and ensuring that the amplified audio signal keeps any residual unwanted noise at a less perceptible (or imperceptible) level.

Conventional hearing assistance appliances amplify all sound captured, including ambient and other noise outside of a desired audio source (e.g., a particular person's voice with whom a user is having a conversation). By amplifying such unwanted noise, the user may have difficulty focusing on and understanding the desired audio source. To address these problems and others, a hearing enhancement system described herein with respect to some implementations can determine which audio source to accentuate in an audio signal, apply a combination of filters to the audio signal to remove as much unwanted noise as possible, and determine an amount of residual noise left outside of the target audio source after the filtering. The hearing enhancement system can then determine, based on the determined amount of residual noise left in the audio signal, an amount of amplification to apply to the audio signal, such that the residual noise stays below a particular level that is less noticeable to the user (e.g., below a level of ambient noise in the real-world environment).

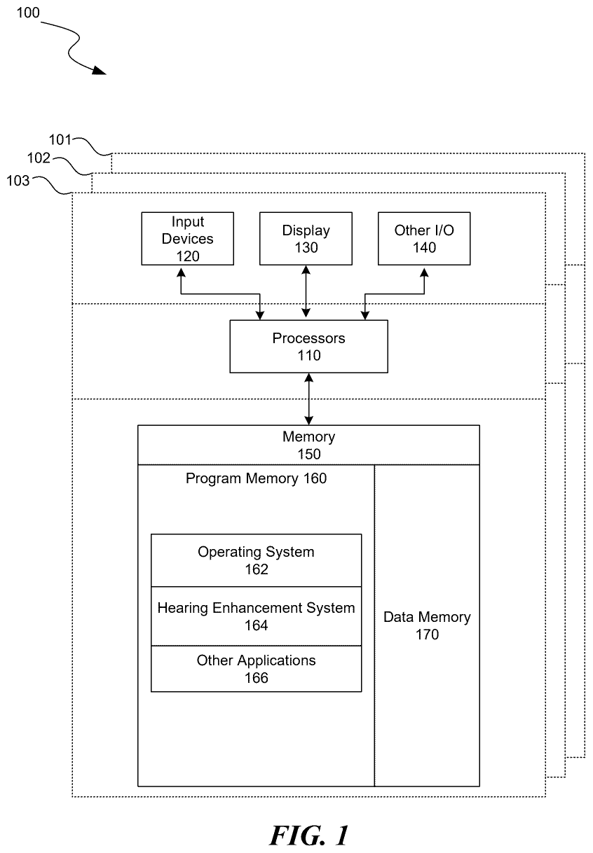

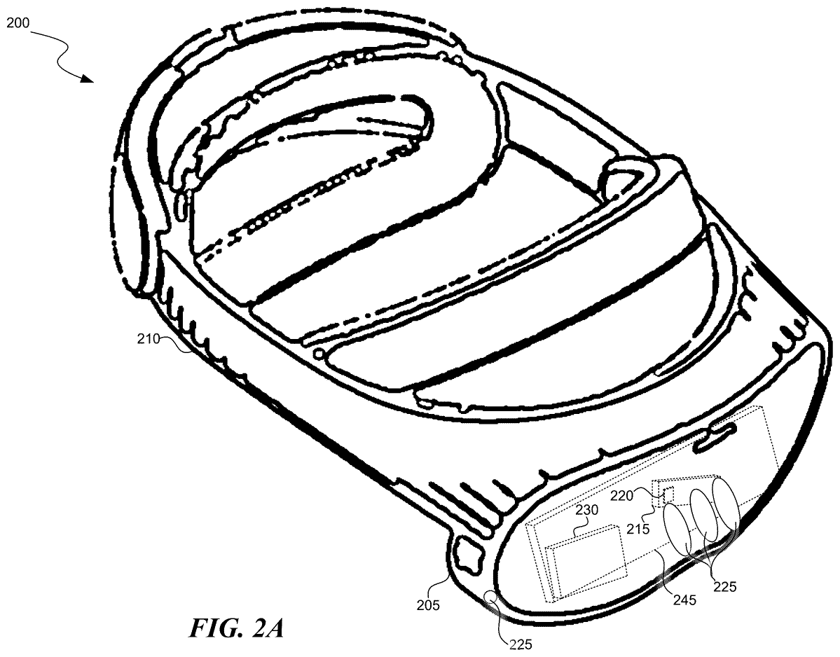

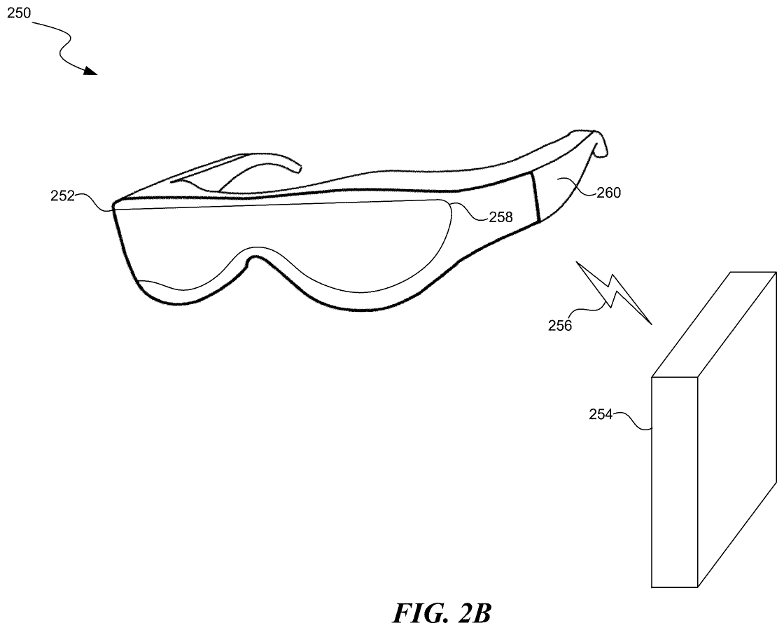

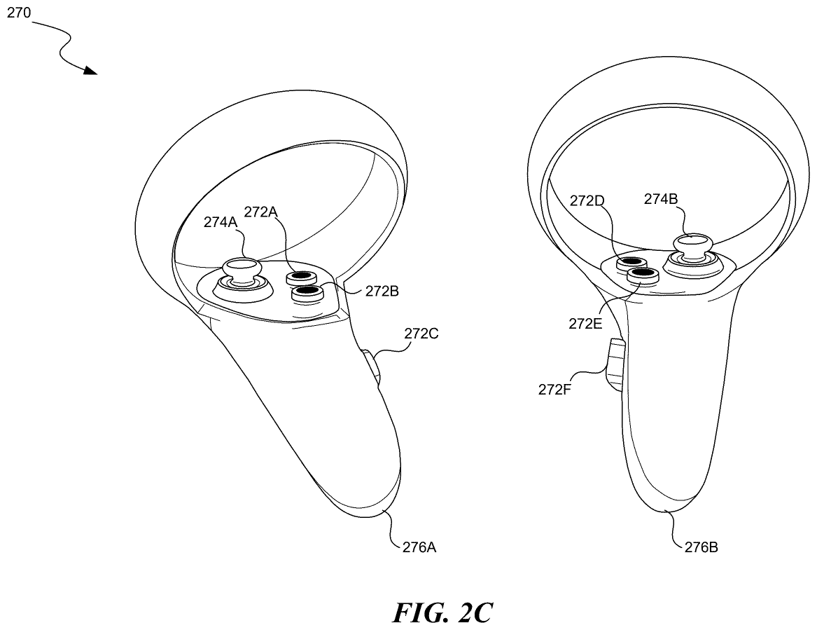

Several implementations are discussed below in more detail in reference to the figures. FIG. 1 is a block diagram illustrating an overview of devices on which some implementations of the disclosed technology can operate. The devices can comprise hardware components of a computing system 100 that can provide hearing enhancement. In various implementations, computing system 100 can include a single computing device 103 or multiple computing devices (e.g., computing device 101, computing device 102, and computing device 103) that communicate over wired or wireless channels to distribute processing and share input data. In some implementations, computing system 100 can include a stand-alone headset capable of providing a computer created or augmented experience for a user without the need for external processing or sensors. In other implementations, computing system 100 can include multiple computing devices such as a headset and a core processing component (such as a console, mobile device, or server system) where some processing operations are performed on the headset and others are offloaded to the core processing component. Example headsets are described below in relation to FIGS. 2A and 2B. In some implementations, position and environment data can be gathered only by sensors incorporated in the headset device, while in other implementations one or more of the non-headset computing devices can include sensor components that can track environment or position data.

Computing system 100 can include one or more processor(s) 110 (e.g., central processing units (CPUs), graphical processing units (GPUs), holographic processing units (HPUs), etc.) Processors 110 can be a single processing unit or multiple processing units in a device or distributed across multiple devices (e.g., distributed across two or more of computing devices 101-103).

Computing system 100 can include one or more input devices 120 that provide input to the processors 110, notifying them of actions. The actions can be mediated by a hardware controller that interprets the signals received from the input device and communicates the information to the processors 110 using a communication protocol. Each input device 120 can include, for example, a mouse, a keyboard, a touchscreen, a touchpad, a wearable input device (e.g., a haptics glove, a bracelet, a ring, an earring, a necklace, a watch, etc.), a camera (or other light-based input device, e.g., an infrared sensor), a microphone, or other user input devices.

Processors 110 can be coupled to other hardware devices, for example, with the use of an internal or external bus, such as a PCI bus, SCSI bus, or wireless connection. The processors 110 can communicate with a hardware controller for devices, such as for a display 130. Display 130 can be used to display text and graphics. In some implementations, display 130 includes the input device as part of the display, such as when the input device is a touchscreen or is equipped with an eye direction monitoring system. In some implementations, the display is separate from the input device. Examples of display devices are: an LCD display screen, an LED display screen, a projected, holographic, or augmented reality display (such as a heads-up display device or a head-mounted device), and so on. Other I/O devices 140 can also be coupled to the processor, such as a network chip or card, video chip or card, audio chip or card, USB, firewire or other external device, camera, printer, speakers, CD-ROM drive, DVD drive, disk drive, etc.

In some implementations, input from the I/O devices 140, such as cameras, depth sensors, IMU sensor, GPS units, LiDAR or other time-of-flights sensors, etc. can be used by the computing system 100 to identify and map the physical environment of the user while tracking the user's location within that environment. This simultaneous localization and mapping (SLAM) system can generate maps (e.g., topologies, grids, etc.) for an area (which may be a room, building, outdoor space, etc.) and/or obtain maps previously generated by computing system 100 or another computing system that had mapped the area. The SLAM system can track the user within the area based on factors such as GPS data, matching identified objects and structures to mapped objects and structures, monitoring acceleration and other position changes, etc.

Computing system 100 can include a communication device capable of communicating wirelessly or wire-based with other local computing devices or a network node. The communication device can communicate with another device or a server through a network using, for example, TCP/IP protocols. Computing system 100 can utilize the communication device to distribute operations across multiple network devices.

The processors 110 can have access to a memory 150, which can be contained on one of the computing devices of computing system 100 or can be distributed across of the multiple computing devices of computing system 100 or other external devices. A memory includes one or more hardware devices for volatile or non-volatile storage, and can include both read-only and writable memory. For example, a memory can include one or more of random access memory (RAM), various caches, CPU registers, read-only memory (ROM), and writable non-volatile memory, such as flash memory, hard drives, floppy disks, CDs, DVDs, magnetic storage devices, tape drives, and so forth. A memory is not a propagating signal divorced from underlying hardware; a memory is thus non-transitory. Memory 150 can include program memory 160 that stores programs and software, such as an operating system 162, hearing enhancement system 164, and other application programs 166. Memory 150 can also include data memory 170 that can include, e.g., audio signal data, target signal data, residual noise data, ambient noise data, filtering data, directional data, amplification data, attenuation data, configuration data, settings, user options or preferences, etc., which can be provided to the program memory 160 or any element of the computing system 100.

In various implementations, the technology described herein can include a non-transitory computer-readable storage medium storing instructions, the instructions, when executed by a computing system, cause the computing system to perform steps as shown and described herein. In various implementations, the technology described herein can include a computing system comprising one or more processors and one or more memories storing instructions that, when executed by the one or more processors, cause the computing system to steps as shown and described herein.

Some implementations can be operational with numerous other computing system environments or configurations. Examples of computing systems, environments, and/or configurations that may be suitable for use with the technology include, but are not limited to, XR headsets, personal computers, server computers, handheld or laptop devices, cellular telephones, wearable electronics, gaming consoles, tablet devices, multiprocessor systems, microprocessor-based systems, set-top boxes, programmable consumer electronics, network PCs, minicomputers, mainframe computers, distributed computing environments that include any of the above systems or devices, or the like.

FIG. 2A is a wire diagram of a virtual reality head-mounted display (HMD) 200, in accordance with some embodiments. In this example, HMD 200 also includes augmented reality features, using passthrough cameras 225 to render portions of the real world, which can have computer generated overlays. The HMD 200 includes a front rigid body 205 and a band 210. The front rigid body 205 includes one or more electronic display elements of one or more electronic displays 245, an inertial motion unit (IMU) 215, one or more position sensors 220, cameras and locators 225, and one or more compute units 230. The position sensors 220, the IMU 215, and compute units 230 may be internal to the HMD 200 and may not be visible to the user. In various implementations, the IMU 215, position sensors 220, and cameras and locators 225 can track movement and location of the HMD 200 in the real world and in an artificial reality environment in three degrees of freedom (3DoF) or six degrees of freedom (6DoF). For example, locators 225 can emit infrared light beams which create light points on real objects around the HMD 200 and/or cameras 225 capture images of the real world and localize the HMD 200 within that real world environment. As another example, the IMU 215 can include e.g., one or more accelerometers, gyroscopes, magnetometers, other non-camera-based position, force, or orientation sensors, or combinations thereof, which can be used in the localization process. One or more cameras 225 integrated with the HMD 200 can detect the light points. Compute units 230 in the HMD 200 can use the detected light points and/or location points to extrapolate position and movement of the HMD 200 as well as to identify the shape and position of the real objects surrounding the HMD 200.

The electronic display(s) 245 can be integrated with the front rigid body 205 and can provide image light to a user as dictated by the compute units 230. In various embodiments, the electronic display 245 can be a single electronic display or multiple electronic displays (e.g., a display for each user eye). Examples of the electronic display 245 include: a liquid crystal display (LCD), an organic light-emitting diode (OLED) display, an active-matrix organic light-emitting diode display (AMOLED), a display including one or more quantum dot light-emitting diode (QOLED) sub-pixels, a projector unit (e.g., microLED, LASER, etc.), some other display, or some combination thereof.

In some implementations, the HMD 200 can be coupled to a core processing component such as a personal computer (PC) (not shown) and/or one or more external sensors (not shown). The external sensors can monitor the HMD 200 (e.g., via light emitted from the HMD 200) which the PC can use, in combination with output from the IMU 215 and position sensors 220, to determine the location and movement of the HMD 200.

FIG. 2B is a wire diagram of a mixed reality HMD system 250 which includes a mixed reality HMD 252 and a core processing component 254. The mixed reality HMD 252 and the core processing component 254 can communicate via a wireless connection (e.g., a 60 GHz link) as indicated by link 256. In other implementations, the mixed reality system 250 includes a headset only, without an external compute device or includes other wired or wireless connections between the mixed reality HMD 252 and the core processing component 254. The mixed reality HMD 252 includes a pass-through display 258 and a frame 260. The frame 260 can house various electronic components (not shown) such as light projectors (e.g., LASERs, LEDs, etc.), cameras, eye-tracking sensors, MEMS components, networking components, etc.

The projectors can be coupled to the pass-through display 258, e.g., via optical elements, to display media to a user. The optical elements can include one or more waveguide assemblies, reflectors, lenses, mirrors, collimators, gratings, etc., for directing light from the projectors to a user's eye. Image data can be transmitted from the core processing component 254 via link 256 to HMD 252. Controllers in the HMD 252 can convert the image data into light pulses from the projectors, which can be transmitted via the optical elements as output light to the user's eye. The output light can mix with light that passes through the display 258, allowing the output light to present virtual objects that appear as if they exist in the real world. In some cases, however, it is contemplated that core processing component 254 is not needed, and the display 258 can be an inert glasses lens.

Similarly to the HMD 200, the HMD system 250 can also include motion and position tracking units, cameras, light sources, etc., which allow the HMD system 250 to, e.g., track itself in 3DoF or 6DoF, track portions of the user (e.g., hands, feet, head, or other body parts), map virtual objects to appear as stationary as the HMD 252 moves, and have virtual objects react to gestures and other real-world objects.

FIG. 2C illustrates controllers 270 (including controller 276A and 276B), which, in some implementations, a user can hold in one or both hands to interact with an artificial reality environment presented by the HMD 200 and/or HMD 250. The controllers 270 can be in communication with the HMDs, either directly or via an external device (e.g., core processing component 254). The controllers can have their own IMU units, position sensors, and/or can emit further light points. The HMD 200 or 250, external sensors, or sensors in the controllers can track these controller light points to determine the controller positions and/or orientations (e.g., to track the controllers in 3DoF or 6DoF). The compute units 230 in the HMD 200 or the core processing component 254 can use this tracking, in combination with IMU and position output, to monitor hand positions and motions of the user. The controllers can also include various buttons (e.g., buttons 272A-F) and/or joysticks (e.g., joysticks 274A-B), which a user can actuate to provide input and interact with objects.

In various implementations, the HMD 200 or 250 can also include additional subsystems, such as an eye tracking unit, an audio system, various network components, etc., to monitor indications of user interactions and intentions. For example, in some implementations, instead of or in addition to controllers, one or more cameras included in the HMD 200 or 250, or from external cameras, can monitor the positions and poses of the user's hands to determine gestures and other hand and body motions. As another example, one or more light sources can illuminate either or both of the user's eyes and the HMD 200 or 250 can use eye-facing cameras to capture a reflection of this light to determine eye position (e.g., based on set of reflections around the user's cornea), modeling the user's eye and determining a gaze direction.

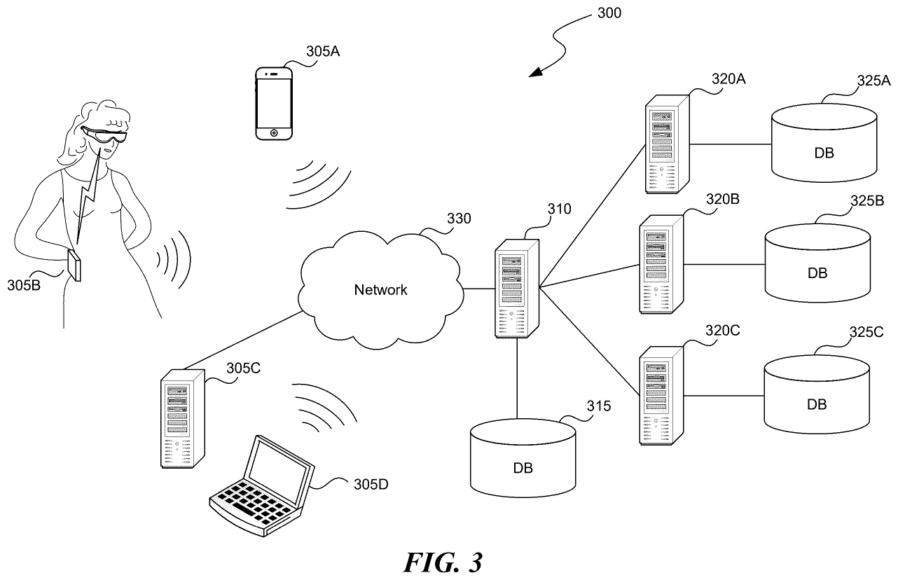

FIG. 3 is a block diagram illustrating an overview of an environment 300 in which some implementations of the disclosed technology can operate. Environment 300 can include one or more client computing devices 305A-D, examples of which can include computing system 100. In some implementations, some of the client computing devices (e.g., client computing device 305B) can be the HMD 200 or the HMD system 250. Client computing devices 305 can operate in a networked environment using logical connections through network 330 to one or more remote computers, such as a server computing device.

In some implementations, server 310 can be an edge server which receives client requests and coordinates fulfillment of those requests through other servers, such as servers 320A-C. Server computing devices 310 and 320 can comprise computing systems, such as computing system 100. Though each server computing device 310 and 320 is displayed logically as a single server, server computing devices can each be a distributed computing environment encompassing multiple computing devices located at the same or at geographically disparate physical locations.

Client computing devices 305 and server computing devices 310 and 320 can each act as a server or client to other server/client device(s). Server 310 can connect to a database 315. Servers 320A-C can each connect to a corresponding database 325A-C. As discussed above, each server 310 or 320 can correspond to a group of servers, and each of these servers can share a database or can have their own database. Though databases 315 and 325 are displayed logically as single units, databases 315 and 325 can each be a distributed computing environment encompassing multiple computing devices, can be located within their corresponding server, or can be located at the same or at geographically disparate physical locations.

Network 330 can be a local area network (LAN), a wide area network (WAN), a mesh network, a hybrid network, or other wired or wireless networks. Network 330 may be the Internet or some other public or private network. Client computing devices 305 can be connected to network 330 through a network interface, such as by wired or wireless communication. While the connections between server 310 and servers 320 are shown as separate connections, these connections can be any kind of local, wide area, wired, or wireless network, including network 330 or a separate public or private network.

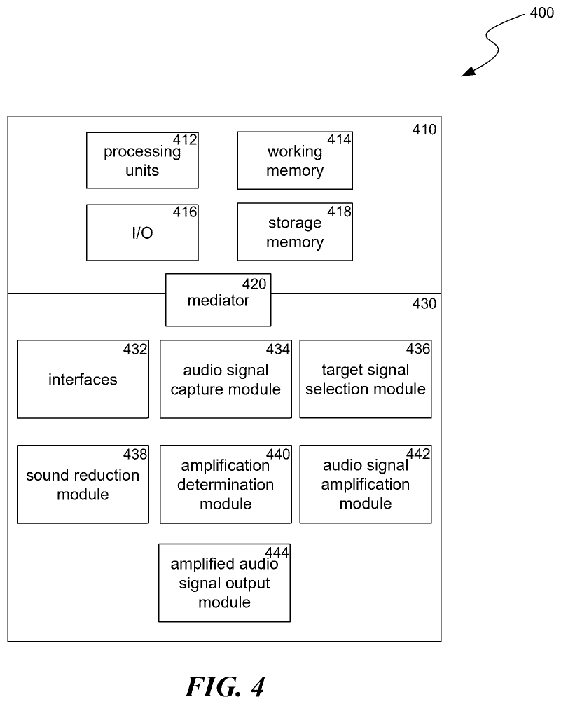

FIG. 4 is a block diagram illustrating components 400 which, in some implementations, can be used in a system employing the disclosed technology. Components 400 can be included in one device of computing system 100 or can be distributed across multiple of the devices of computing system 100. The components 400 include hardware 410, mediator 420, and specialized components 430. As discussed above, a system implementing the disclosed technology can use various hardware including processing units 412, working memory 414, input and output devices 416 (e.g., cameras, displays, IMU units, network connections, etc.), and storage memory 418. In various implementations, storage memory 418 can be one or more of: local devices, interfaces to remote storage devices, or combinations thereof. For example, storage memory 418 can be one or more hard drives or flash drives accessible through a system bus or can be a cloud storage provider (such as in storage 315 or 325) or other network storage accessible via one or more communications networks. In various implementations, components 400 can be implemented in a client computing device such as client computing devices 305 or on a server computing device, such as server computing device 310 or 320.

Mediator 420 can include components which mediate resources between hardware 410 and specialized components 430. For example, mediator 420 can include an operating system, services, drivers, a basic input output system (BIOS), controller circuits, or other hardware or software systems.

Specialized components 430 can include software or hardware configured to perform operations for providing hearing enhancement. Specialized components 430 can include audio signal capture module 434, target signal selection module 436, sound reduction module 438, amplification determination module 440, audio signal amplification module 442, amplified audio signal output module 444, and components and APIs which can be used for providing user interfaces, transferring data, and controlling the specialized components, such as interfaces 432. In some implementations, components 400 can be in a computing system that is distributed across multiple computing devices or can be an interface to a server-based application executing one or more of specialized components 430. Although depicted as separate components, specialized components 430 may be logical or other nonphysical differentiations of functions and/or may be submodules or code-blocks of one or more applications.

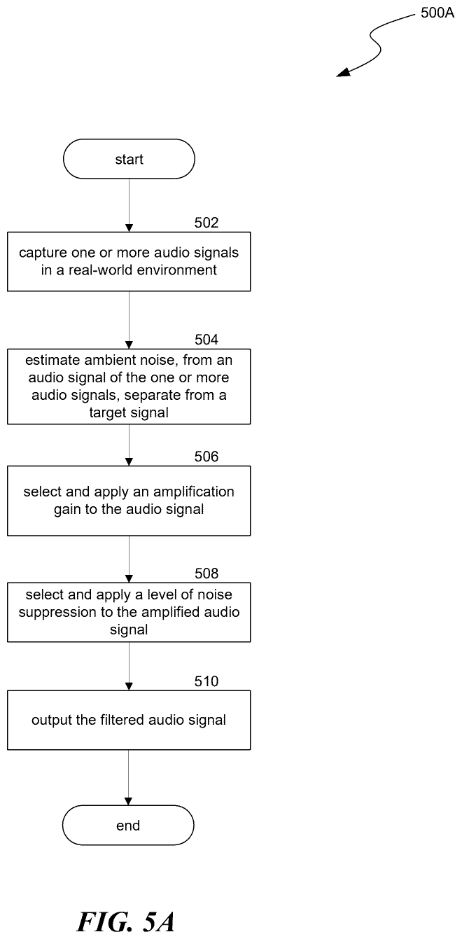

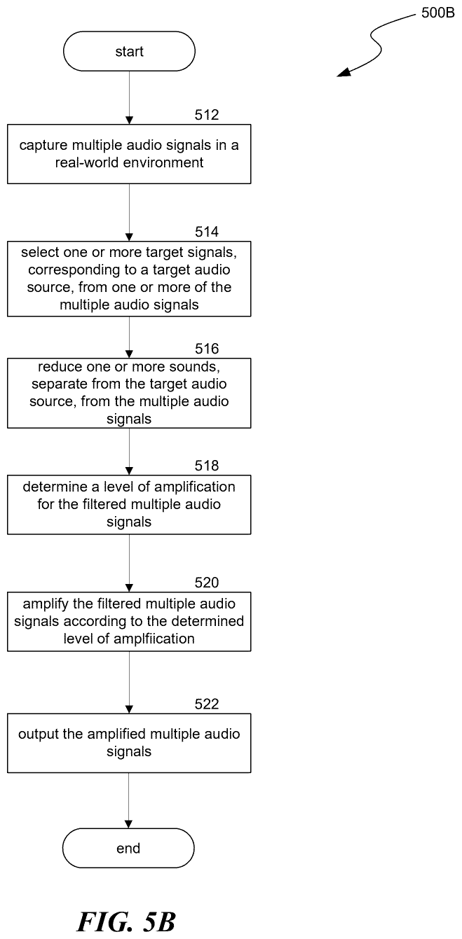

Audio signal capture module 434 can capture one or more audio signals, in a real-world environment, from one or more microphones, such as are included in input and output devices 416. In some implementations, audio signal capture module 434 can capture multiple audio signals from an array of microphones. In some implementations, the array of microphones can be positioned at particular known locations and/or orientations on an XR system, such that directionality of audio signals captured by such microphones can be ascertained. Further details regarding capturing audio signals from an array of microphones are described herein with respect to block 502 of FIG. 5A and block 522 of FIG. 5B.

In some implementations, target signal selection module 436 can select one or more target signals, corresponding to a target audio source, from one or more of the audio signals. In some implementations, the target audio source can be a human voice, which in some cases can be a particular person's voice. Thus, in some implementations, the one or more target signals can be signals corresponding to a person speaking. In some implementations, target signal selection module 436 can select the one or more target signals based on a directionality of their capture, as determined based on which and at what volume particular microphones of the array captured the target signals. For example, in some implementations, target signal selection module 436 can select a target signal determined to be in front of the XR system's user. For example, target signal selection module 436 can compare inputs from two or more microphones, of an array of microphones, to determine the relative strength of the audio signals to identify which is in front of the user. Similarly, in some implementations, target signal selection module 436 can compare inputs from three or more microphones to triangulate a location of the source of an audio signal to identify which is in front of the user. Although described primarily herein as selecting a target signal in front of the user, it is contemplated that target signal selection module 436 can similarly select a target signal from any other direction relative to the user in a similar manner (i.e., the target audio source can be at any position relative to the user ascertainable by the methods described above). Further details regarding selecting one or more target signals, corresponding to a target audio source, from one or more of multiple audio signals, are described herein with respect to block 514 of FIG. 5B.

In some implementations, sound reduction module 438 can reduce one or more sounds, separate from the one or more target signals, from one or more audio signals, by filtering the audio signal(s) and/or applying other noise reduction techniques (e.g., selectively lowering the volume of noise outside of a target signal, i.e., ambient noise). In some implementations in which directionality of the target signal(s) is known, sound reduction module 438 can apply spatial filtering to reduce and/or remove sounds originating from other directions. Alternatively or additionally, sound reduction module 438 can apply spectral filtering to the one or more of the multiple audio signals to remove frequencies outside of the range of a human voice and/or outside the determined range of a particular person's voice. In some implementations, sound reduction module 438 can select a level of filtering and/or other noise suppression to apply to the audio signal based on an amount of amplification applied or to be applied to the audio signal, based on an amount of artifacts that are predicted to result to the target signal by application of the noise reduction, etc. Further details regarding reducing one or more sounds, separate from one or more target signals, by filtering one or more of the multiple audio signals are described herein with respect to block 508 of FIG. 5A and block 516 of FIG. 5B.

Amplification determination module 440 can determine a level of amplification for the audio signal(s). In some implementations, amplification determination module 440 can determine the level of amplification based on an estimated amount of ambient noise, separate from a target signal (e.g., a signal corresponding to a voice), in an audio signal. Amplification determination module 440 can then select the level of amplification to increase intelligibility or reduce listening effort, without applying large amplification if it is not needed. For example, if the target audio signal has a high volume relative to the volume of the ambient noise (e.g., twice as loud, or another ratio of loudness greater than a threshold), less amplification would need to be applied than to an audio signal where the target audio signal has a volume closer to the volume of the ambient noise. In some implementations, amplification determination module 440 can estimate the amount of ambient noise by estimating a noise level outside of the identified target audio signal. Further details regarding estimating ambient noise from an audio signal and selecting and applying a particular level of amplification are described herein with respect to blocks 504 and 506, respectively, of FIG. 5A.

In some implementations, amplification determination module 440 can determine the level of amplification based on a determined amount of residual noise, in the filtered audio signal(s), separate from the one or more target signals. The residual noise can correspond to any noise left in the audio signal(s) that could not be filtered out and that does not correspond to the target audio source (e.g., a person's voice). In some implementations, amplification determination module 440 can estimate the amount of residual noise in the filtered audio signal(s). In some implementations, amplification determination module 440 can predict the amount of residual noise based on the type of filtering applied by sound reduction module 438 (e.g., spatial and/or spectral filtering) and a mapping of an expected amount of residual noise left after filtering an audio signal using such methods.

In some implementations, amplification determination module 440 can determine the level of amplification by selecting a level at which the residual noise, in the filtered audio signal(s), does not exceed a threshold. The threshold can correspond to, for example, an amount of ambient noise in the real-world environment, such that the residual noise is masked by the ambient noise. In another example, the threshold can correspond to a particular volume level (e.g., 45 decibels) that is below an average volume of human speech in a conversation. In some implementations, amplification determination module 440 can alternatively or additionally determine a level of attenuation for an audio signal, such as when the residual noise is above a threshold. Further details regarding determining a level of amplification for filtered audio signal(s) based on a determined amount of residual noise are described herein with respect to block 518 of FIG. 5B.

Audio signal amplification module 442 can amplify the one or more of the audio signal(s) according to the level of amplification determined by amplification determination module 440. Because the audio signal(s) have been filtered of as much residual noise as possible, and the audio signal has only been amplified to a level that keeps the residual noise below a threshold (e.g., a determined amount of ambient noise), the XR system's user can better hear and/or focus on the target audio (e.g., a voice) as compared to conventional hearing aids that amplify all noise equally. As noted above, in some implementations, audio signal amplification module 442 can alternatively or additionally attenuate audio signal(s) according to a determined level of attenuation. Amplified audio signal output module 444 can cause the audio signal(s), amplified by audio signal amplification module 442, to be output by at least one speaker, such as is included in input and output devices 416. Further details regarding amplifying filtered audio signals according to a determined level of amplification are described herein with respect to block 510 of FIG. 5A and block 520 of FIG. 5B. Further details regarding outputting amplified audio signal(s) are described herein with respect to block 510 of FIG. 5A and block 522 of FIG. 5B.

Those skilled in the art will appreciate that the components illustrated in FIGS. 1-4 described above, and in each of the flow diagrams discussed below, may be altered in a variety of ways. For example, the order of the logic may be rearranged, substeps may be performed in parallel, illustrated logic may be omitted, other logic may be included, etc. In some implementations, one or more of the components described above can execute one or more of the processes described below.

FIG. 5A is a flow diagram illustrating a first process 500A used in some implementations for providing hearing enhancement by an artificial reality (XR) system. In process 500A, amplification gain is selected based on an estimated amount of ambient noise in an audio signal, and a level of noise suppression is applied to keep residual noise below the estimated amount of ambient noise, but capped at a threshold. In some implementations, some or all of process 500A can be performed by an XR system including one or more XR devices, e.g., an XR head-mounted display (HMD) (such as XR HMD 200 of FIG. 2A and/or XR HMD 252 of FIG. 2B), one or more external processing components, etc. In some implementations, however, the XR system need not include a display. In some implementations, at least some of process 500A can be performed by one or more computing systems remote from the XR system, such as a cloud or edge computing system. For example, one or more components of an XR system (e.g., an XR head-mounted display (HMD)) can perform the capture and output steps described below relative to blocks 502 and 510, while one or more remote servers and/or one or more other components of an XR system (e.g., external processing components) can perform the signal processing steps described below relative to blocks 504-508.

In some implementations, process 500A can be performed upon detection of audio in a real-world environment surrounding the XR system (e.g., by one or more microphones integral with or in operable communication with the XR system). In some implementations, process 500A can be performed “on demand” based on an application-level, system-level, or user request. The user request can be made via the XR system (or another device in operable communication with the XR system) via, for example, selection of an option to perform hearing enhancement via a user interface (e.g., from a virtual menu overlaid onto a view of the real-world environment via the XR system, from an application executing on a separate mobile device, etc.), performing a particular gesture captured via one or more cameras and/or wearable devices and identified by the XR system, making an audible announcement captured via one or more microphones and identified by the XR system, interacting with the XR system (e.g., performing one or a series of taps with one or more fingers on the XR system as detected by one or more sensors of an inertial measurement unit (IMU), such as a three finger tap and hold), or any combination thereof.

In some implementations, process 500A can be performed automatically based on fulfillment of one or more predetermined conditions specified by the XR system, an XR application executing on the XR system, and/or by a user of the XR system. For example, process 500A can be performed automatically (e.g., absent an explicit user request) based a detected amount of noise in the real-world environment (e.g., loudness above a threshold), based on detection of a voice coming from a predetermined direction relative to the XR system (e.g., facing the face of the wearer of the XR system), based on a user profile indicating hearing difficulty (e.g., as explicitly indicated by the user, based on a previously performed hearing test, based on previous interactions with the user with the XR system and as identified by applying a machine learning model to such interactions, etc.), or any combination thereof.

In some implementations, process 500A can be performed in real-time or near real-time as audio is captured in the real-world environment. As used herein, “real-time” or “near real-time” can indicate that the input data (e.g., the captured audio signals) are processed within a threshold time limit, e.g., 10-50 milliseconds. For example, an audio signal captured at block 502 can be processed in blocks 504-508 and output at block 510 in under 50 milliseconds. In some implementations, “real-time” or “near real-time” can indicate that the difference between the audio being heard and processed by the user from the real-world environment and the audio being heard and processed by the user from the XR system is imperceptible to the user (e.g., within 5 tenths of a second).

At block 502, process 500A can capture one or more audio signals, in a real-world environment, from one or more microphones integral with or in operable communication with the XR system. In some implementations, process 500A can capture multiple audio signals from the real-world environment from multiple microphones, such as microphones arranged in an array on the XR system. In some implementations, the microphones can have known positions and/or orientations on the XR system and, in some implementations, known positions and/or orientations relative to one or more other microphones on the XR system. In some implementations, at least one microphone can be outward facing (e.g., facing away from the face of the user of the XR system), such that sound in the real-world environment can be better captured.

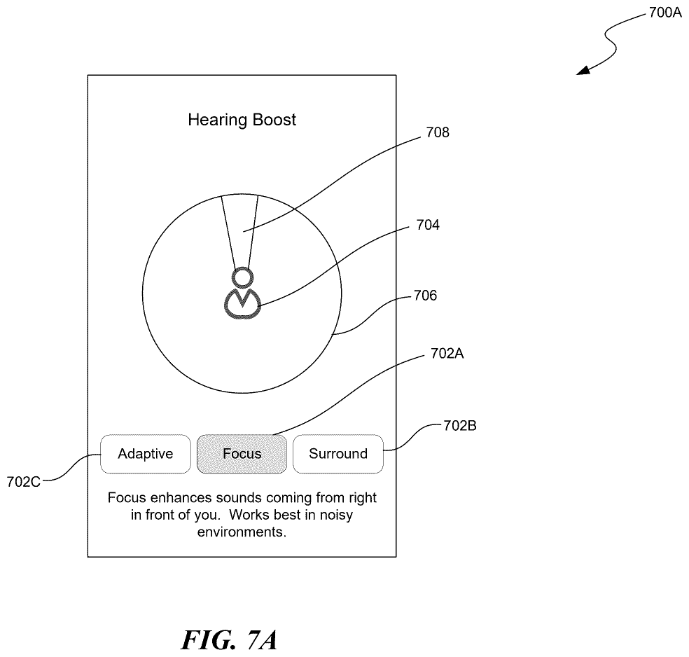

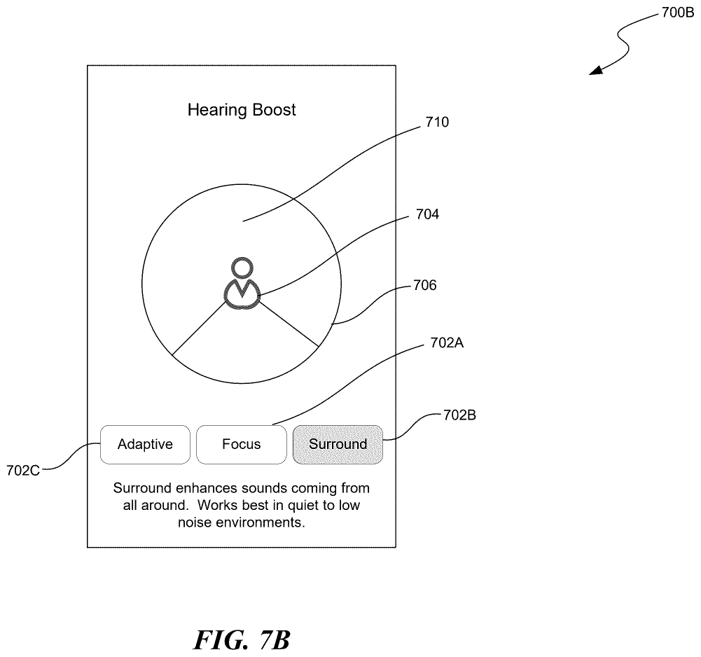

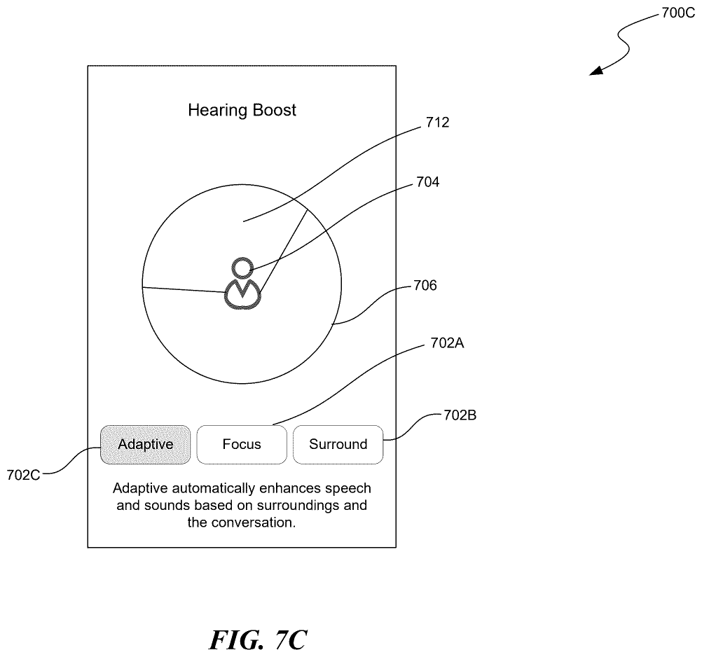

At block 504, process 500A can estimate an amount of ambient noise from the audio signal(s). In some implementations, process 500A can estimate the amount of ambient noise by detecting a target signal from the captured audio signal(s), e.g., corresponding to a voice of a target audio source (e.g., another human speaking to a user of the XR system). In some implementations, process 500A can identify the target signal based on one or more rules, e.g., an audio signal having a highest captured volume relative to other noises in the audio signal, an audio signal coming from a particular direction relative to the XR system (e.g., as ascertained by triangulating signals captured by multiple microphones), an audio signal corresponding to a voice and/or a particular person's voice (e.g., as identified by a machine learning model trained to identify human voices), etc. In some implementations, process 500A can select the target signal based on a mode in which the XR system is operating, e.g., a “focus” mode, a “surround” mode, or an “adaptive” mode, as described further herein with respect to FIG. 5B and FIGS. 7A-7C. In some implementations, process 500A can select the target signal in a similar manner as that described with respect to block 514 of FIG. 5B. Process 500A can then ascertain the level of ambient noise by identifying audio signals outside of the target audio signal. In some implementations, process 500A can determine the level of ambient noise by detecting the lowest volume level audio within the audio signal (e.g., assuming that the target audio has the highest volume level within the audio signal). In some implementations, process 500A can estimate the amount of ambient noise by averaging the noise power over time frames where there is only noise (e.g., without either the target audio or the user's own voice).

At block 506, process 500A can, based on the amount of ambient noise estimated at block 504, select and apply an amplification gain to an audio signal of the one or more audio signals. Process 500A can select the target amplification gain level to increase intelligibility and/or reduce listening effort, without applying a large amplification if it is not needed. For example, process 500A can amplify the audio signal such that the target audio signal is at a particular level (e.g., 55 decibels) or within a particular range (e.g., 40 to 80 decibels), depending on the amount of estimated ambient noise. In some implementations, process 500A can amplify the audio signal more if the ambient noise is relatively high (e.g., 60-70 decibels), and less if the ambient noise is relatively low (e.g., 30-40 decibels). In other words, process 500A can apply more amplification to improve the intelligibility and audibility of target audio only when this is affected by ambient noise, and does not apply as much amplification when the conditions are better. In some implementations, process 500 can select the amplification gain based on user data (e.g., as stored in a user profile, as predicted from user interactions, etc.), such as data indicating that the user of the XR system has hearing loss (and/or a particular level or type of hearing loss). Although described primarily herein relative to an amplification gain, it is contemplated that process 500A can similarly determine a level of attenuation to apply to one or more portions of an audio signal, such as is described further herein with respect to FIG. 5B.

At block 508, based on the amplification gain selected and applied at block 506, process 500A can select and apply a level of noise suppression to the amplified audio signal (e.g., filtering to remove ambient noise and/or lowering the volume of ambient noise). Process 500A can select the level of noise suppression to apply such that the final amount of residual noise that will be output, in the noise-suppressed audio signal, remains below the estimated level of ambient noise, and is thus masked by the ambient noise in the real-world environment. In some implementations, however, the selected amount of noise suppression can be capped at a particular threshold, as applying a higher level of noise suppression can increase the likelihood of a greater number of artifacts resulting in the target audio (e.g., a voice or particular set of voices in the audio signal). In some implementations, the amount of noise suppression can be selected by applying a transform function defining an amount of reduction of ambient noise in the audio signal that will not result in an unacceptable amount of artifacts to the amplified target audio (e.g., an amount of artifacts below a threshold). In some implementations, the predefined transform function can be created through a previous analysis of how various transfer function parameters affect artifacts in filtered audio, and/or how noticeable or perceptible residual noise is in filtered audio in relation to ambient noise. In some implementations, process 500A can apply spatial filtering and/or spectral filtering to the amplified audio signal, such as is further described herein with respect to block 516 of FIG. 5B.

At block 510, process 500A can output, by at least one speaker of the XR system, the audio signal with the amplification gain and the selected level of noise suppression. In some implementations, to output the audio signal, process 500A can higher and/or lower the volume to the desired level, which, in some cases, can be gradual, e.g., according to a linearly increasing and/or decreasing relationship over time, at a predetermined rate (e.g., 1 decibel per 0.5 seconds), etc. Thus, according to FIG. 5A, process 500A can compute the amount of ambient noise to set the level of amplification. The amount of residual noise can depend on the amplification and on the noise reduction aggressiveness. Thus, process 500A can control the noise reduction aggressiveness to limit the audible residual noise at a given amplification output level.

FIG. 5B is a flow diagram illustrating a second process 500B used in some implementations for providing hearing enhancement by an artificial reality (XR) system. In some implementations, process 500B can filter an audio signal, determine a level of amplification for the filtered audio signal based on an amount of residual noise remaining in the audio signal, and amplify and output the filtered audio signal. In some implementations, some or all of process 500B can be performed by an XR system including one or more XR devices, e.g., an XR head-mounted display (HMD) (such as XR HMD 200 of FIG. 2A and/or XR HMD 252 of FIG. 2B), one or more external processing components, etc. In some implementations, however, the XR system need not include a display. In some implementations, at least some of process 500B can be performed by one or more computing systems remote from the XR system, such as a cloud or edge computing system. For example, one or more components of an XR system (e.g., an XR head-mounted display (HMD)) can perform the capture and output steps described below relative to blocks 512 and 522, while one or more remote servers and/or one or more other components of an XR system (e.g., external processing components) can perform the signal processing steps described below relative to blocks 514-520.

In some implementations, process 500B can be performed upon detection of audio in a real-world environment surrounding the XR system (e.g., by one or more microphones integral with or in operable communication with the XR system). In some implementations, process 500B can be performed “on demand” based on an application-level, system-level, or user request. The user request can be made via the XR system (or another device in operable communication with the XR system) via, for example, selection of an option to perform hearing enhancement via a user interface (e.g., from a virtual menu overlaid onto a view of the real-world environment via the XR system, from an application executing on a separate mobile device, etc.), performing a particular gesture captured via one or more cameras and/or wearable devices and identified by the XR system, making an audible announcement captured via one or more microphones and identified by the XR system, interacting with the XR system (e.g., performing one or a series of taps with one or more fingers on the XR system as detected by one or more sensors of an inertial measurement unit (IMU), such as a three finger tap and hold), or any combination thereof.

In some implementations, process 500B can be performed automatically based on fulfillment of one or more predetermined conditions specified by the XR system, an XR application executing on the XR system, and/or by a user of the XR system. For example, process 500B can be performed automatically (e.g., absent an explicit user request) based a detected amount of noise in the real-world environment (e.g., loudness above a threshold), based on detection of a voice coming from a predetermined direction relative to the XR system (e.g., facing the face of the wearer of the XR system), based on a user profile indicating hearing difficulty (e.g., as explicitly indicated by the user, based on a previously performed hearing test, based on previous interactions with the user with the XR system and as identified by applying a machine learning model to such interactions, etc.), or any combination thereof.

In some implementations, process 500B can be performed in real-time or near real-time as audio is captured in the real-world environment. As used herein, “real-time” or “near real-time” can indicate that the input data (e.g., the captured audio signals) are processed within a threshold time limit, e.g., 10-50 milliseconds. For example, an audio signal captured at block 512 can be processed in blocks 514-520 and output at block 522 in under 50 milliseconds. In some implementations, “real-time” or “near real-time” can indicate that the difference between the audio being heard and processed by the user from the real-world environment and the audio being heard and processed by the user from the XR system is imperceptible to the user (e.g., within 5 tenths of a second).

At block 512, process 500B can capture one or more audio signals in a real-world environment via one or more microphones integral with or in operable communication with the XR system. In some implementations, process 500B can capture multiple audio signals from the real-world environment from multiple microphones, such as microphones arranged in an array on the XR system. In some implementations, the microphones can have known positions and/or orientations on the XR system and, in some implementations, known positions and/or orientations relative to one or more other microphones on the XR system. In some implementations, at least one microphone can be outward facing (e.g., facing away from the face of the user of the XR system), such that sound in the real-world environment can be better captured.

At block 514, process 500B can select one or more target signals, corresponding to a target audio source, from one or more of the captured multiple audio signals (e.g., one or more of the audio signals that include the target signal). In some implementations, the target audio source can be a voice, and the target signal can be an audio signal (or portion of an audio signal) corresponding to the voice. In some implementations, process 500B can identify the voice within the target signal by extracting relevant features of the voice (e.g., frequency, pitch, spectral envelope, etc.), and comparing those features to a database of known voices using one or more pattern recognition and/or machine learning algorithms.

In some implementations, process 500B can identify any human voice from the audio signal, whereas in other implementations, process 500B can identify a particular human voice from the audio (e.g., corresponding to a particular person known and/or previously encountered by the user of the XR system and having a sample of their voice stored in the database). For example, process 500B can compare the voice in the audio signal to only those voices known to the user (e.g., having a sample stored in the database), and only select the voice if it matches a voice stored in the database. In some implementations, the target audio source need not be a voice, and can instead be any other predetermined noise (e.g., a song) that can be identified from an audio signal based on a unique audio fingerprint associated with the noise and matched to audio fingerprints of known noises.

In some implementations, process 500B can select the one or more target signals, including the target audio source (e.g., the voice), based on a determination that the one or more target signals (e.g., an audio waveform corresponding to the voice) are being captured from a predetermined direction relative to the XR system. For example, process 500B can determine that a particular voice is captured by one or more microphones in a position and orientation facing directly away from the face of the user wearing the XR system (e.g., from a microphone positioned on the XR system between where the user's eye are positioned). In some implementations, it is contemplated that process 500B can select the one or more target signals based on their capture from the predetermined direction regardless of their volume relative to other captured signals (e.g., a softer volume of the target audio source relative to other audio sources). However, in some implementations, process 500B can additionally select the one or more target signals based on a determination that the particular target audio source is captured loudest by such microphone(s) relative to other microphone(s) in other positions and/or orientations on the XR system. In some implementations, process 500B can select the one or more target signals based on the loudest target source from amongst the audio signals, regardless of the direction of their capture relative to the XR system.

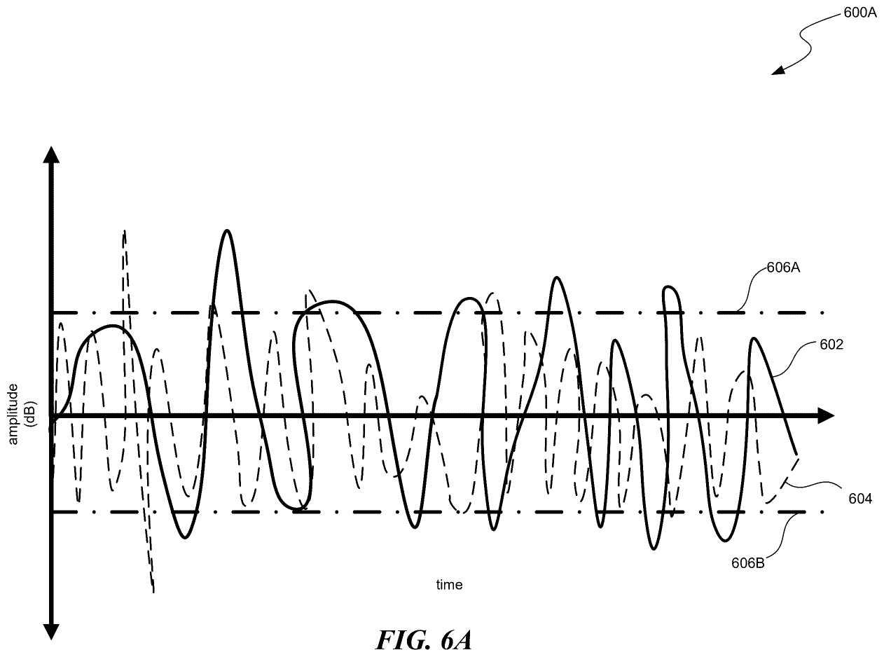

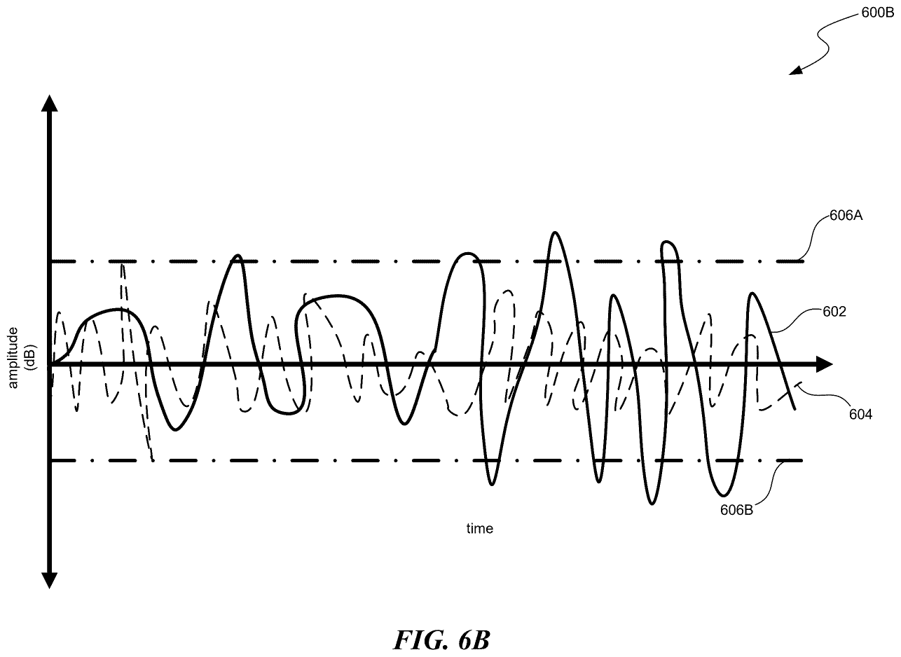

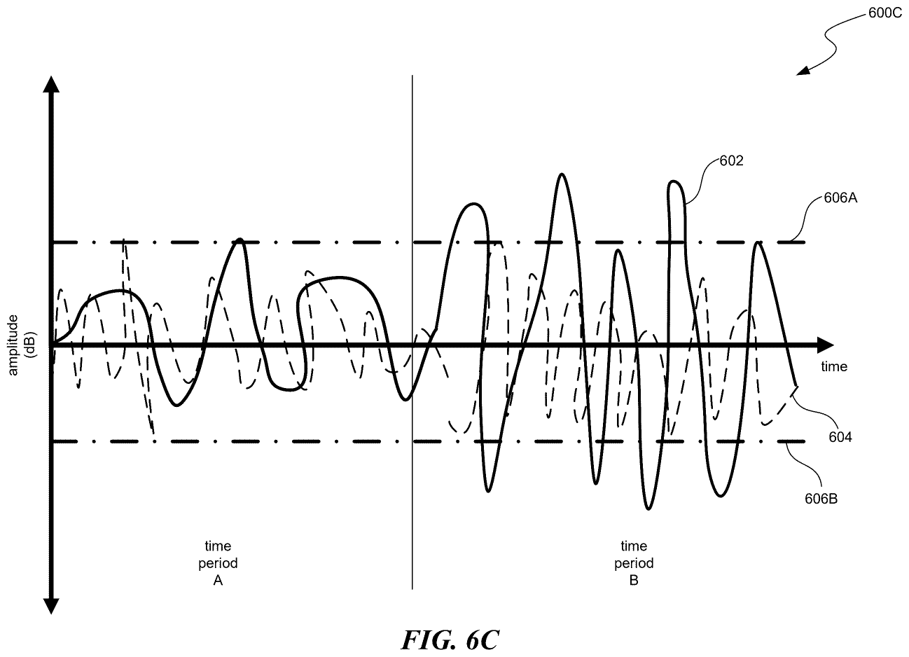

In some implementations, the predetermined direction can include an angular range projecting outward from the XR system into the real-world environment. In some implementations, the angular range can be selected by the user of the XR system. In some implementations, process 500B can automatically select the angular range based on one or more factors, such as an amount of ambient noise in the real-world environment. For example, for a relatively low amount of ambient noise (e.g., ambient noise below a threshold, such as 40 decibels), process 500B can select a first, relatively wide angular range to amplify more captured audio from the real-world environment, such as in a “surround mode” as illustrated and described herein relative to FIG. 6B. In another example, for a relatively high amount of ambient noise (e.g., ambient noise above a threshold, such as 60 decibels), process 500B can select a second, relatively narrow angular range to capture and amplify less captured audio in a real-world environment, e.g., only audio captured from a particular direction (e.g., facing the XR system's user), such as in a “focus mode” as illustrated and described herein relative to FIG. 6A. In some implementations, process 500B can automatically select the angular range by applying a machine learning model trained on previous user selections in the context of other factors, such as loudness of the target audio signal, level of ambient noise in the real-world environment, level of residual noise in the audio signal, a number of users in a conversation (e.g., capturing a wider range for more users), etc., as identified from the audio signal(s) and/or via image(s) captured by one or more cameras.

In some implementations, process 500B can alternatively or additionally select the one or more target signals, including the target audio source (e.g., the voice), based on one or more factors other than the direction of capture of the target audio signal(s). For example, process 500B can identify the target audio source based on the gaze of the XR system's user, captured by one or more cameras facing the eyes of the user, and projected into the real-world environment intersecting with and/or at a vergence depth corresponding to the target audio source. In another example, process 500B can identify the target audio source based on a gesture indicating the target audio source (e.g., pointing at a particular person or other audio source, circling an area with the finger corresponding to a particular person or other audio source, etc.), with the gesture captured by one or more cameras and interpreted by the XR system. In some implementations, upon identifying the target audio source, process 500B can display an indication of the target audio source, such as by darkening an area around the target audio source such that the target audio source appears highlighted, displaying a virtual object indicative of the location of the target audio source (e.g., a virtual arrow toward or virtual circle around the target audio source) overlaid on a view of the real-world environment, etc.

At block 506, process 500B can reduce one or more sounds, separate from the one or more target signals, from the one or more of the multiple audio signals, by filtering the one or more of the multiple audio signals. In some implementations, process 500B can filter the audio signals by applying spatial filtering. In some implementations, because the audio signals are captured by an array of microphones, spatial filtering can discriminate sound sources based on their position in the real-world environment by filtering sounds coming from different directions than the target audio source (e.g., a particular voice), even if they have overlapping spectral content. In some implementations, however, process 500B can continue filtering sounds separate from the target audio source regardless of the direction of capture of the target audio source, such as when the target audio source moves away from a location in front of and facing the XR system's user.

In some implementations, process 500B can filter the audio signal(s) by applying spectral filtering, separately or in conjunction with machine learning techniques. In some implementations, process 500B can filter the audio signal(s) based on the known statistical time-frequency representation of the target audio source and how that differs from that of other noise sources, such as ambient noise sources. For example, based on the known frequency range of the target audio source (e.g., a frequency range corresponding to a human voice and/or a frequency range corresponding to a particular voice), process 500B can remove some signal portion(s) in some time-frequency representation(s) in the audio signal(s) corresponding to unwanted non-speech noise. In some implementations, process 500B can filter out the XR system user's own voice from the audio signal(s). For example, process 500B can analyze acoustic features of a target voice (e.g., a person standing in front of the XR system's user), and/or the acoustic features of the XR system user's voice, such as pitch, frequency, articulation, speaking rate, intonation, etc. Process 500B can perform voice differentiation to filter the XR system user's voice from the audio signal(s) using any suitable technique, such as dynamic time warping (DTW), Gaussian mixture models (GMM), mel-frequency cepstral coefficients (MFCCs), machine learning models trained on training data including audio samples of the XR system user's own voice, deep learning networks (e.g., convolutional neural networks (CNNs) that learn voice features directly from raw audio data), and/or the like. In some implementations, process 500B can filter the audio signal(s) by applying a combination of multiple of such filtering techniques.

At block 518, process 500B can determine a level of amplification and/or attenuation for the filtered one or more of the multiple audio signals based on a determined amount of residual noise, in the filtered one or more of the multiple signals, separate from the target audio source. The residual noise can correspond to any remaining sounds left in the audio signal(s) outside of the target audio source (e.g., a particular voice) after the filtering has been completed. In some implementations, process 500B can measure the amount of residual noise left in the audio signal by subtracting the target audio signal from the filtered audio signal. In some implementations, process 500B can predict and/or estimate the amount of residual noise left in the audio signal based on the type of filtering applied to the signal (e.g., spatial and/or spectral) using a mapping of the type of filtering to an expected amount of residual noise for given circumstances (e.g., amplitude, frequency, pitch, etc. of the captured audio signal and/or target audio signal). Process 500B can then select a corresponding level of amplification and/or attenuation based on the predicted amount of residual noise, without measuring the residual noise. In some implementations, the determined level of amplification and/or attenuation can be proportional to the determined amount of residual noise in the filtered audio signal(s).

In some implementations, process 500B can determine a level of amplification and/or attenuation for the audio signal(s) by comparing the amplitude of the residual noise to a threshold (e.g., in decibels or pascals). For example, if the threshold is 40 decibels and the residual noise is 30 decibels, process 500B can determine a level of amplification for the audio signal(s) of 10 decibels. In another example, if the threshold is 35 decibels and the residual noise is 45 decibels, process 500B can determine a level of attenuation of 10 decibels for the audio signal(s). In some implementations, process 500B can amplify the audio signal(s) as much as possible while keeping the residual noise below a threshold.

In some implementations, process 500B can determine the level of amplification and/or attenuation for the audio signal(s) such that the residual noise falls between a predetermined range (e.g., 20 to 30 decibels). In some implementations, the level of amplification and/or attenuation for the audio signal(s) can be selected such that the residual noise is masked by ambient noise in the real-world environment. For example, process 500B can measure an amount of ambient noise surrounding the XR device (e.g., using one or more microphones and a sound level meter application), then select the level of amplification and/or attenuation such that the amount of residual noise remains below the amount of ambient noise. In some implementations, the level of amplification and/or attenuation can have upper and/or lower limits, respectively, such that the audio signal(s) (and/or the target audio signal, e.g., the audio signal corresponding to a particular voice) does not become too loud or too soft, e.g., the amplitude of the overall audio signal(s) (including the residual noise) and/or the amplitude of the target audio signal remains between 55-65 decibels.

In some implementations, process 500B can dynamically adjust the level of amplification and/or attenuation as audio signal(s) are received based on a changing level of residual noise, a changing amplitude of the target audio signal, a changing level of ambient noise, or any combination thereof. In some implementations, process 500B can determine the level of amplification and/or attenuation over a predetermined time period (e.g., every 5 seconds). In some implementations, process 500B can re-determine the level of amplification and/or attenuation based on occurrence of a triggering event, such as a level of residual noise rising above a threshold, volume of a target audio source rising above or falling below a threshold, etc.

At block 510, process 500B can amplify and/or attenuate the filtered one or more of the multiple audio signals according to the determined level of amplification and/or attenuation. Unlike conventional hearing enhancement systems, process 500B can amplify and/or attenuate the audio signal(s) after they have been filtered of as much residual noise as possible, allowing the XR system's user to focus on the target audio. In some implementations, when changing the level of amplification and/or attenuation, process 500B can gradually higher and/or lower the volume to the desired level, e.g., according to a linearly increasing and/or decreasing relationship over time, at a predetermined rate (e.g., 1 decibel per second), etc. At block 512, process 500B can output the amplified one or more of the multiple audio signals, such as through one or more speakers.

Although illustrated and described herein as separate implementations, it is contemplated that the implementations (or portions thereof) described relative to FIGS. 5A and 5B can be freely and/or selectively combined. Further, although illustrated and described as being performed in a single iteration, it is contemplated that process 500A of FIG. 5A and/or process 500B of FIG. 5B can be performed repetitively, either concurrently or consecutively, as audio signals are being captured. Further, it is contemplated that the XR system can perform process 500A of FIG. 5A and/or process 500B of FIG. 5B, and/or vice versa, for particular audio signals and/or over different periods of time, based on any of a number of factors, such as which process results in an output audio signal with the least amount of artifacts, the most amount of noise reduction, the highest level of amplification of the target signal relative to the residual and/or ambient noise, etc.

In some implementations, the hearing enhancement system described herein can select to perform process 500B of FIG. 5B, instead of process 500A of FIG. 5A, when the XR system cannot control the noise reduction aggressiveness and its residual artifacts in full. In one example, process 500B of FIG. 5B can be selected if the priority for a specific user experience is to limit audible residual noise, rather than to provide amplification benefit. In still another example, process 500B can be an extension of process 500A. For example, the hearing enhancement system can have a target amplification range for each measured ambient noise level rather than a single target value. In this case, the hearing enhancement system can always provide minimal amplification regardless of the residual noise, but can also adaptively increase the amplification to a maximum target level, if the measured residual noise can be kept below the ambient noise level.

FIG. 6A is a graph 600A illustrating an exemplary filtered audio signal (602 and 604 together), including a target audio signal 602 and residual noise 604. A hearing enhancement system described herein can capture multiple audio signals in a real-world environment from an array of microphones positioned at various locations on the XR system, and attempt to isolate a target audio source (e.g., a human voice) by filtering one or more of the audio signals to remove as much noise as possible. Graph 600A illustrates an exemplary output of such filter(s), where residual noise 604 has been reduced relative to the captured audio signal (not shown).

Graph 600A further illustrates exemplary thresholds 606A-606B for residual noise that should not be exceeded. Thresholds 606A-606B can be selected based on any factor or combination of factors. For example, thresholds 606A-606B can correspond to a value less than an average conversation sound level (e.g., 60 dB), such that residual noise 604 does not interfere with human conversation. In another example, thresholds 606A-606B can correspond to a value less than a loudness of ambient noise in the real-world environment. In still another example, thresholds 606A-606B can be set manually by a user of the XR system.

Although illustrated as static and linear, it is contemplated that, in some implementations, thresholds 606A-606B can be automatically and/or dynamically changed at particular points in time or over time based on fulfillment of one or more conditions. For example, thresholds 606A-606B can be adjusted up or down based on the amplitude of the target audio signal 602 (and, correspondingly, volume of the target audio source) goes up or down, allowing for greater residual noise when a voice is louder and less residual noise when a voice is softer. In another example, thresholds 606A-606B can be adjusted up or down based on an amount of ambient noise detected in the real-world environment, such that residual noise 604 stays below the ambient noise heard by the user of the XR system.

Based on thresholds 606A-606B, the hearing enhancement system can amplify and/or attenuate the filtered audio signal 602, 604. FIG. 6B is a graph 600B illustrating an exemplary filtered audio signal 602, 604 that has been attenuated to reduce the overall amount of residual noise 604. As shown in graph 600B, the entire filtered audio signal 602, 604 has been attenuated over time (i.e., amplitude has been reduced), such that residual noise 604 remains within thresholds 606A-606B.

FIG. 6C is a graph 600C illustrating an exemplary filtered audio signal 602, 604 that has been dynamically adjusted over multiple time periods to attenuate the filtered audio signal 602, 604 in a first time period (time period A) and amplify the filtered audio signal in another time period (time period B). In time period A, both target audio signal 602 and residual noise 604 has been attenuated, such that residual noise 604 stays within thresholds 606A-606B. In time period B, both target audio signal 602 and residual noise 604 has been amplified, allowing the amplitude of residual noise 604 to increase up to thresholds 606A-606B while also amplifying target audio signal 602. Thus, the overall volume of filtered audio signal 602, 604 can be decreased in time period A and increased in time period B. It is contemplated that time periods A and B can be set and/or selected based on any factor or combination of factors, such as corresponding to a fixed predetermined time interval (e.g., every 5 seconds), corresponding to a time in which an average or integral of residual noise 604 rises above or below thresholds 606A-606B, corresponding to a time at which residual noise 604 momentarily peaks outside of thresholds 606A-606B, corresponding to a time at which residual noise 604 falls below a further threshold, etc.

FIG. 7A is an exemplary user interface 700A for selecting and controlling a focus mode (corresponding to virtual button 702A) of a hearing enhancement system according to some implementations of the present technology. In some implementations, upon activation of the hearing enhancement system on an XR system, user interface 700A can be displayed on another device in operable communication with the XR system, such as a mobile device (e.g., a smartphone). In some implementations, however, it is contemplated that user interface 700A (or any portion thereof) can be displayed on the XR system itself, overlaid onto a view of the real-world environment. In still other implementations, user interface 700A need not be displayed on the XR system or another device, and control of the hearing enhancement system can be made via interactions with the XR system (e.g., taps, gestures, selections of physical buttons, etc.).

In exemplary FIG. 7A, user interface 700A can present three modes of hearing enhancement: a focus mode corresponding to virtual button 702A, a surround mode corresponding to virtual button 702B, and an adaptive mode 702C corresponding to virtual button 702C. User interface 700A can further present graphics indicative of a user 704 wearing the XR system in a real-world environment 706 surrounding user 704. In this example, the user has selected (or the hearing enhancement system has automatically selected, as described further herein) a focus mode corresponding to virtual button 702A. As indicated on user interface 700A, the focus mode can enhance sounds coming from right in front of user 704, and can work best in noisy environments (e.g., a noise level above a threshold). User interface 700A further presents graphics indicative of an angular range 708, of real-world environment 706, relative to user 704, in which sound is amplified and/or attenuated according to a determined amount of residual noise left after filtering, as described further herein.

Although described herein as selecting sounds coming from right in front of user 704, it is contemplated that, in the focus mode (as well as in the surround and/or adaptive mode described further herein in some implementations), the hearing enhancement system can enhance sounds coming from any direction relative to user 704, with a narrow angular range 708 relative to a surround mode, as described further herein. In some implementations, the hearing enhancement system can automatically steer angular range 708 by the position of the target audio source (where the speaking person or other sound source of interest could be off center) and/or dynamically change the position of angular range 708 as the XR system's user or target audio source's location change relative to each other. To determine the region of interest (which can include both angular range 708, as well as a distance from user 704 and/or an orientation relative to user 704), the target audio source location can be learned from the audio signal, and/or from other signals, such as from signals of one or more sensors of an inertial measurement unit (IMU) and/or image(s) captured by one or more cameras of the XR system.

FIG. 7B is an exemplary user interface 700B for selecting and controlling a surround mode of a hearing enhancement system according to some implementations of the present technology. In this example, the user has selected (or the hearing enhancement system has automatically selected, as described further herein) the surround mode corresponding to virtual button 702B. As indicated on user interface 700B, the surround mode can enhance sounds coming from a wide area around user 704, and works best in quiet to low noise environments (e.g., a noise level below a threshold). User interface 700B further presents graphics indicative of an angular range 710, of real-world environment 706, relative to user 704, in which sound is amplified and/or attenuated according to a determined amount of residual noise left after filtering, as described further herein. In some implementations, in the surround mode, the hearing enhancement system can amplify a wider range of sounds surrounding user 704, while still providing a level of filtering of residual noise to enhance a target audio source (e.g., a particular voice in front of the user).

FIG. 7C is an exemplary user interface 700C for selecting and controlling an adaptive mode of a hearing enhancement system according to some implementations of the present technology. In this example, the user has selected (or the hearing enhancement system has automatically selected, as described further herein) the adaptive mode corresponding to virtual button 702C. As indicated on user interface 700C, the adaptive mode can automatically enhance speech and/or sounds based on surroundings and the conversation. For example, the hearing enhancement system can automatically and/or dynamically adjust angular range 712 to narrow angular range 708 of FIG. 7A, widen angular range 710 of FIG. 7B, and/or anywhere in between based on how noisy the real-world environment is, the direction in which a voice is captured from, etc. As shown in FIG. 7C, and as noted above and described further herein, angular range 712 need not be symmetric relative to a facing direction of user 704, centered relative to a facing direction of user 704, and/or in front of user 704, and can be set at any direction relative to user 704 based on any of a number of factors (e.g., selection of an area from which the target audio is detected, selection of an audio from which the loudest volume is detected, etc.), which, in some implementations, can be dynamically changed over time. Although described in FIG. 7C as the adaptive mode being automatically controlled by the hearing enhancement system, it is contemplated that, in some implementations, the XR system's user can manually select and/or adjust the size of angular range 712, such as via a slider or other user interface object, and in some implementations, in three dimensions.

Several implementations of the disclosed technology are described above in reference to the figures. The computing devices on which the described technology may be implemented can include one or more central processing units, memory, input devices (e.g., keyboard and pointing devices), output devices (e.g., display devices), storage devices (e.g., disk drives), and network devices (e.g., network interfaces). The memory and storage devices are computer-readable storage media that can store instructions that implement at least portions of the described technology. In addition, the data structures and message structures can be stored or transmitted via a data transmission medium, such as a signal on a communications link. Various communications links can be used, such as the Internet, a local area network, a wide area network, or a point-to-point dial-up connection. Thus, computer-readable media can comprise computer-readable storage media (e.g., “non-transitory” media) and computer-readable transmission media.

Reference in this specification to “implementations” (e.g., “some implementations,” “various implementations,” “one implementation,” “an implementation,” etc.) means that a particular feature, structure, or characteristic described in connection with the implementation is included in at least one implementation of the disclosure. The appearances of these phrases in various places in the specification are not necessarily all referring to the same implementation, nor are separate or alternative implementations mutually exclusive of other implementations. Moreover, various features are described which may be exhibited by some implementations and not by others. Similarly, various requirements are described which may be requirements for some implementations but not for other implementations.

As used herein, being above a threshold means that a value for an item under comparison is above a specified other value, that an item under comparison is among a certain specified number of items with the largest value, or that an item under comparison has a value within a specified top percentage value. As used herein, being below a threshold means that a value for an item under comparison is below a specified other value, that an item under comparison is among a certain specified number of items with the smallest value, or that an item under comparison has a value within a specified bottom percentage value. As used herein, being within a threshold means that a value for an item under comparison is between two specified other values, that an item under comparison is among a middle-specified number of items, or that an item under comparison has a value within a middle-specified percentage range. Relative terms, such as high or unimportant, when not otherwise defined, can be understood as assigning a value and determining how that value compares to an established threshold. For example, the phrase “selecting a fast connection” can be understood to mean selecting a connection that has a value assigned corresponding to its connection speed that is above a threshold.

As used herein, the word “or” refers to any possible permutation of a set of items. For example, the phrase “A, B, or C” refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described above. Specific embodiments and implementations have been described herein for purposes of illustration, but various modifications can be made without deviating from the scope of the embodiments and implementations. The specific features and acts described above are disclosed as example forms of implementing the claims that follow. Accordingly, the embodiments and implementations are not limited except as by the appended claims.

Any patents, patent applications, and other references noted above are incorporated herein by reference. Aspects can be modified, if necessary, to employ the systems, functions, and concepts of the various references described above to provide yet further implementations. If statements or subject matter in a document incorporated by reference conflicts with statements or subject matter of this application, then this application shall control.

I/We claim:

1. A method for providing hearing enhancement by an artificial reality system, the method comprising:
capturing one or more audio signals, in a real-world environment, from one or more microphones;
estimating a level of ambient noise from the one or more audio signals;
based on the estimated level of ambient noise, selecting and applying an amplification gain to an audio signal of the one or more audio signals;
based on the selected amplification gain for the audio signal, selecting a level of noise suppression to apply to the audio signal having the applied amplification gain, such that an amount of remaining residual noise is below the estimated level of ambient noise;
applying the selected level of noise suppression to the audio signal having the applied amplification gain; and
outputting, by at least one speaker of the artificial reality system, the audio signal having the applied amplification gain and the selected level of noise suppression.

2. The method of claim 1,
wherein the selecting the noise suppression level includes limiting level of noise suppression to a first threshold level, the first threshold level being associated with less than a second threshold amount of resulting artifacts by a predefined transform function relating noise suppression levels of input signals to a resulting artifact amounts in output signals.

3. The method of claim 1, further comprising:
selecting a target signal, corresponding to a target audio source, from the audio signal,
wherein the applying the selected level of noise suppression includes reducing one or more sounds, separate from the target signal, in the audio signal by filtering the audio signal.

4. A method for providing hearing enhancement by an artificial reality system, the method comprising:
capturing multiple audio signals, in a real-world environment, from an array of microphones;
selecting one or more voice signals, corresponding to a voice, from one or more of the multiple audio signals, based on a determination that the one or more voice signals are being captured from a predetermined direction relative to the artificial reality system;
reducing one or more sounds, separate from the one or more voice signals, in the one or more of the multiple audio signals, by filtering the one or more of the multiple audio signals;
determining a level of amplification for the filtered one or more of the multiple audio signals based on a determined amount of residual noise in the filtered one or more of the multiple signals;
amplifying the filtered one or more of the multiple audio signals according to the determined level of amplification; and
outputting, by at least one speaker of the artificial reality system, the amplified one or more of the multiple audio signals.

5. The method of claim 4, wherein the outputting the amplified one or more of the multiple audio signals is in real-time or near real-time relative to the capturing of the multiple audio signals.

6. The method of claim 4, wherein the filtering the one or more of the multiple audio signals includes applying spatial filtering.

7. The method of claim 4, wherein the filtering the one or more of the multiple audio signals includes applying spectral filtering.

8. The method of claim 4,
wherein the voice is a first voice of a first user,
wherein the one or more sounds includes a second voice of a second user, the second user wearing the artificial reality system, and
wherein the filtering the one or more of the multiple audio signals includes applying machine learning-based filtering of a signal corresponding to the second voice.

9. The method of claim 4, wherein the determined level of amplification is proportional to the determined amount of residual noise.

10. The method of claim 4, wherein the amplifying, the filtered one or more of the multiple audio signals, is in response to a detected gesture of a user, of the artificial reality system, relative to the artificial reality system.

11. The method of claim 10, wherein the detected gesture includes one or more taps on the artificial reality system.

12. The method of claim 4, wherein the predetermined direction of the voice is at least partially toward a face of a user of the artificial reality system.

13. The method of claim 4, wherein the predetermined direction includes an angular range relative to the artificial reality system, and wherein the angular range is selected based on a detected amount of ambient noise in the real-world environment.

14. The method of claim 13, wherein the angular range is dynamically adjusted as the detected amount of ambient noise changes.

15. The method of claim 4, wherein the predetermined direction includes an angular range relative to the artificial reality system, and wherein the angular range is selected by a user of the artificial reality system.

16. The method of claim 4, wherein the determining a level of amplification for the filtered one or more of the multiple audio signals is based on the determined amount of residual noise in the filtered one or more of the multiple signals relative to a threshold.

17. A computer-readable storage medium storing instructions, for providing hearing enhancement by an artificial reality system, the instructions, when executed by a computing system, cause the computing system to:
capture multiple audio signals, in a real-world environment, from an array of microphones;
select one or more voice signals, corresponding to a voice, from one or more of the multiple audio signals, based on a determination that the one or more voice signals are being captured from a predetermined direction relative to the artificial reality system;
reduce one or more sounds, separate from the one or more voice signals, from the one or more of the multiple audio signals, by filtering the multiple audio signals;
determine a level of amplification and/or attenuation for the filtered one or more of the multiple audio signals based on a determined amount of residual noise, in the filtered one or more of the multiple signals;
amplify and/or attenuate the filtered one or more of the multiple audio signals according to the determined level of amplification and/or attenuation; and
output, by at least one speaker of the artificial reality system, the amplified and/or attenuated one or more of the multiple audio signals.

18. The computer-readable storage medium of claim 17, wherein the predetermined direction includes an angular range relative to the artificial reality system, and wherein the angular range is selected based on a detected amount of ambient noise in the real-world environment.

19. The computer-readable storage medium of claim 18, wherein the angular range is dynamically adjusted as the detected amount of ambient noise changes.

20. The computer-readable storage medium of claim 17, wherein the filtering the one or more of the multiple audio signals includes applying spatial filtering and spectral filtering.
